(19) United States
(12) Patent Application Publication
(10) Pub. No.: US 2013/0124037 A1
(43) Pub. Date: May 16, 2013

(54) VEHICLE LIGHT CONTROLLER

(71) Applicants: Seng Kiat GOH, Selangor (MY); Seng Toh GOH, Selangor (MY)

(72) Inventors: Seng Kiat GOH, Selangor (MY); Seng Toh GOH, Selangor (MY)

(73) Assignees: SENG TOH GOH, SELANGOR (MY); SENG KIAT GOH, SELANGOR (MY)

(21) Appl. No.: 13/296,651

(22) Filed: Nov. 15, 2011

(51) Int. Cl. B60Q 1/04

(52) U.S. Cl. 701/36

(57) ABSTRACT

A vehicle light controller that uses a microprocessor to automatically control the headlights is disclosed. An infrared sensor is installed in the vehicle to detect feedback signal to transmit the signal to the microprocessor. When the weather is cloudy, dark or rainy, the headlights can be automatically turned on to prevent car accidents and further enhance the safety and convenience when the user drives the vehicle. When infrared intensity is weak, the infrared sensor is triggered to provide a feedback signal to the microprocessor to turn on the headlights. When the infrared intensity reaches a predetermined level, the feedback signal is sent to the microprocessor to shut off the headlights. A monitoring circuit can shut off the power supply when the microprocessor does not work properly or transmit wrong feedback signals to prevent the headlights from being turned on abnormally and prevent the power supply from being uncontrollably drained.

### FIELD OF THE INVENTION

The present invention relates to a vehicle light controller that uses a microprocessor to automatically control on/off of the headlights. An infrared sensor is installed in the vehicle to detect feedback signal to transmit the signal to the microprocessor. When the weather is cloudy, dark or rainy, the headlights can be automatically turn on to prevent car accidents due to the driver's negligence to turn on the headlights, and to further enhance the safety and convenience while driving.

### BACKGROUND OF THE INVENTION

Conventional vehicle light controller uses light-sensitive resistance and light intensity to detect outside light source and generate feedback signals to turn on/off the headlights. However, when the driver drives into a tunnel or underground parking lot, conventional light controller may misjudge the outside environment and does not automatically turn on the headlights. Or when the vehicle on the opposite side of road has strong headlights, the conventional light control may also misjudge to shut off the headlights to cause car accidents. Therefore, there remains a need for a new and improved vehicle light controller to overcome the abovementioned problems.

### SUMMARY OF THE INVENTION

The present invention provides an automatic vehicle light controller that uses a microprocessor to automatically control on/off of the vehicle light. A main feature is that a infrared sensor is disposed in the vehicle to provide feedback signals to the microprocessor, so when the weather is cloudy, dark or rainy, the headlights can be automatically turned on to avoid the driver's negligence for not turning the headlights on, and to further enhance the safety and convenience while driving. When the driver turns on the vehicle electrical lock and the vehicle, the microprocessor starts to control the headlights. The infrared sensor detects infrared intensity at outside light sources and when the infrared is insufficient, the infrared sensor is triggered to generate a signal to the microprocessor to turn on the headlights. The infrared sensor would send a signal to the microprocessor to turn off the headlights when the infrared intensity at outside light sources reaches a predetermined level. Since the wavelength of infrared is more than 775 nm, the infrared sensor is not triggered and confused by other light sources such as visible light and ultraviolet. The infrared sensor can be installed on the body of the vehicle that can be easily receive outside light sources such as the top of the vehicle. Also, the infrared technology is mature so the manufacturing costs are lower than light-sensitive sensors.

A monitoring circuit is formed between the microprocessor and the power supply to shut off the power supply when the microprocessor does not work properly or transmit wrong feedback signals to prevent the headlights from being turned on abnormally, which also prevent the power supply from being uncontrollably drained.

### BRIEF DESCRIPTION OF THE DRAWINGS

FIG. 1 illustrates a block diagram of the microprocessor in the present invention.

FIG. 2 illustrates a schematic view of the present invention installed in the vehicle.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

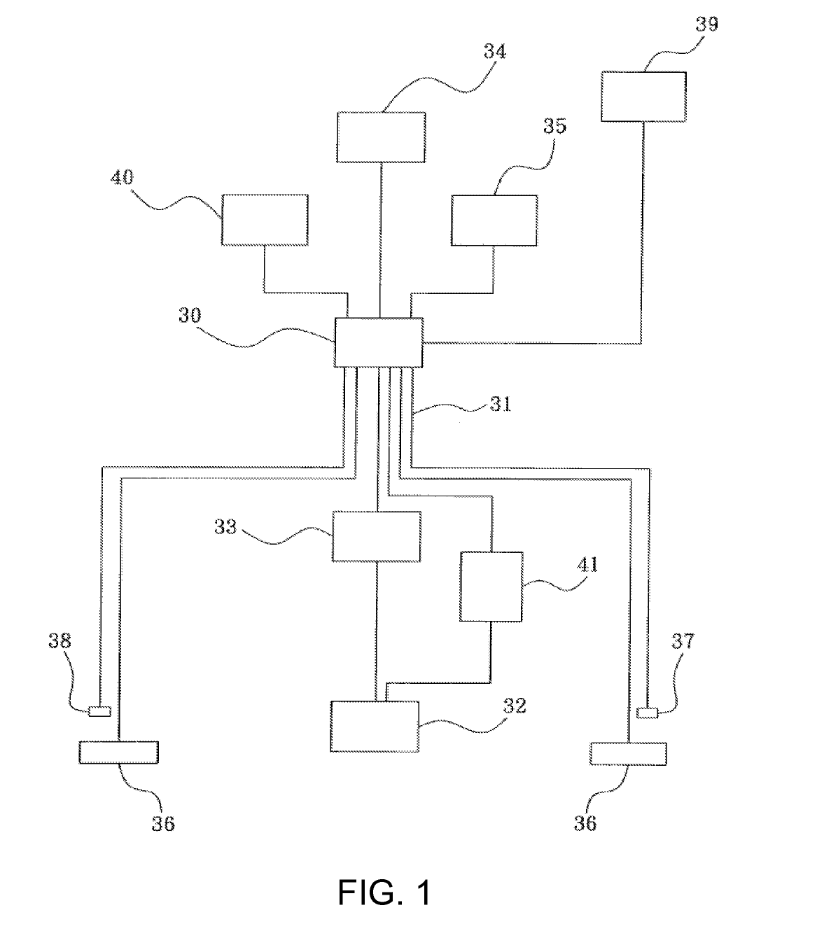

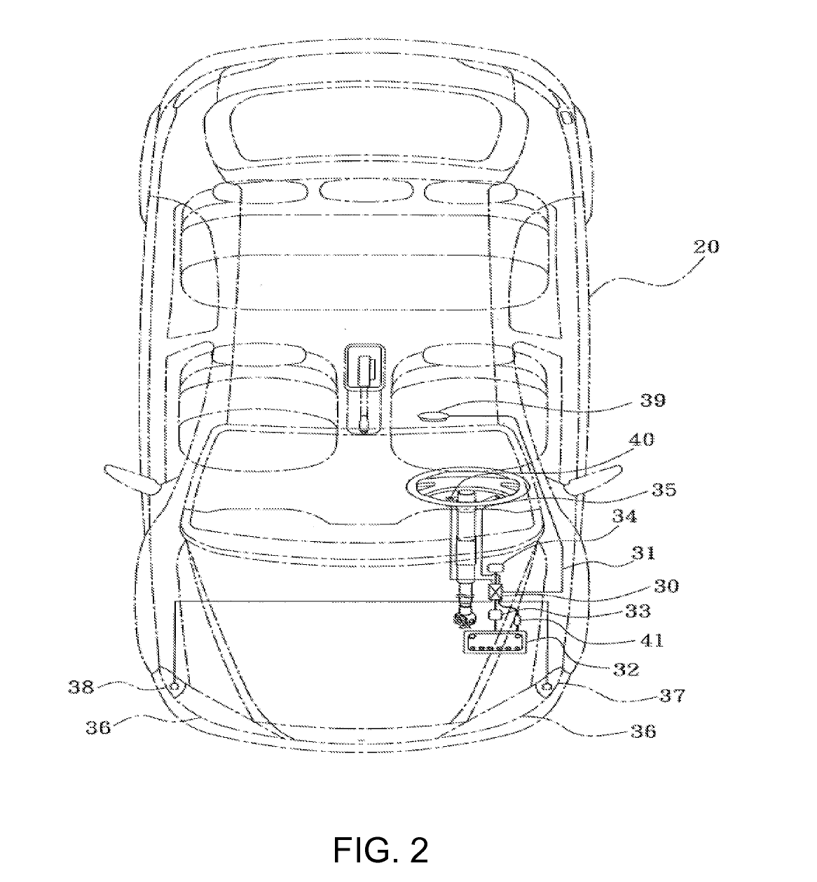

Referring to FIGS. 1 and 2, an automatic vehicle light controller includes a microprocessor (30) inside a vehicle (20) and the microprocessor (30) is connected to a power supply (32), regulator (33), light relay (34), turn light switch (35), headlights (36), left turn light (37), right turn light (38), infrared sensor (39) and vehicle electronic lock (40) through one or more wires (31). A monitoring circuit (41) is formed between the microprocessor (30) and the power supply (32), so that when the microprocessor does not work appropriately or has wrong transmission signals, the power supply (32) is shut off to prevent the headlights (36) from being turned on abnormally, which may cause insufficient power supply. When the driver turns on the vehicle electronic lock (40) and the vehicle, the microprocessor (30) starts to control the headlights (36). The infrared sensor (39) detects infrared intensity at outside light sources and when the infrared is insufficient, the infrared sensor (39) is triggered to generate a signal to the microprocessor (30) to turn on the headlights (36). The infrared sensor (39) would send a signal to the microprocessor to turn off the headlights (36) when the infrared intensity at outside light sources reaches a predetermined level. The microprocessor (30) can be set to stop after the driver slightly touch the turn light switch (35), or after a predetermined period of time using the left turn light (37) and right turn light (38), meaning that it is not necessary for the driver to manually turn off the turn light switch (35). The monitoring circuit (41) can shut off the power supply (32) to prevent the headlights (36) from being turned on abnormally when the microprocessor does not work appropriately or has wrong transmission signals and prevent a battery in the power supply (32) from being uncontrollably drained.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. An automatic vehicle light controller comprising:
a microprocessor inside an vehicle body; and
an infrared sensor,
wherein the microprocessor is connected to a power supply, a regulator, a light relay, a turn light switch, headlights, an infrared sensor and a vehicle electronic lock through one or more wires, and when infrared intensity is weak and detected by the infrared sensor, the infrared sensor generates a feedback signal to the microprocessor to turn on the headlights, and when infrared intensity reaches a predetermined level, the infrared sensor generates another feedback signal to the microprocessor to shut off the headlights.

2. The automatic vehicle light controller of claim 1, wherein a monitoring circuit is formed between the microprocessor and the power supply, and when the microprocessor does not work properly or the feedback signal is incorrect, the power supply is shut off to prevent the headlights from being turned on abnormally and prevent a battery in the power supply from being uncontrollably drained.

3. The automatic vehicle light controller of claim 1, wherein the infrared sensor is triggered by the infrared with wavelength over 775 nm, so the infrared sensor is not triggered by receiving other light sources to generate incorrect feedback signal.
